(19) United States
(12) Patent Application Publication
(10) Pub. No.: US 2016/0109088 A1
(43) Pub. Date: Apr. 21, 2016

(54) THERMALLY CONDUCTIVE PLASTIC HEAT SINK USED TO CONDUCT HEAT IN AUTOMOTIVE LIGHTING

(71) Applicant: Valeo Lighting Systems North America, LLC, Seymour, IN (US)

(72) Inventors: Timothy Joseph Orr, Seymour, IN (US); John Steven Orisich, Columbus, IN (US)

(21) Appl. No.: 14/515,931

(22) Filed: Oct. 16, 2014

(51) Int. Cl. F21S 8/10

(52) U.S. Cl. CPC F21S 48/34; F21S 48/2212; F21S 48/1225; F21S 48/328

(57) ABSTRACT

A headlamp and/or tail light assembly comprising a housing, an outer lens, a thermally conductive plastic situated in operative relationship with the outer lens and a heating element for heating the thermally conductive plastic, wherein when the heating element heats the thermally conductive plastic, heat is directed towards the outer lens.

### BACKGROUND OF THE INVENTION

1. Field of the Invention

This invention relates to a headlamp assembly and a heater and heating system, apparatus and method for use in a headlamp assembly.

2. Description of the Related Art

Vehicles function in a range of environments and often encounter condensation or ice forming on surfaces of the various components of the vehicle, including the headlamp components. Ice buildup on exterior vehicle components, such as the headlamps and rear lights, is a common problem. A typical headlamp assembly comprises an outer housing that receives a reflector, a reflector and a lens or a lens. The reflector has a light source, such as the LED or a discharge lamp, for example. The housing is typically closed at the front by glass or plastic constituting a transparent cover or lens, which allows the emergence therethrough of light produced by the light source and reflected by the reflector. The optical members, such as the reflector or similar apparatus, are placed within the chamber forming a light beam from the light produced by the light source.

The housing also houses the additional accessories and/or additional means necessary for the operation of the headlamp assembly, such as the electronic circuits and controls for controlling the operation of the headlamp and/or means for its mobility, wiring or the like. Such accessories and complementary means are deemed unsightly and are therefore housed within an interior compartment formed at the base of the housing. Also, the direct visual access to the housing wall is often detrimental to the overall appearance and aesthetics of the headlamp assembly as it is often designed in a material that is unattractive to the eye. To prevent visual access to the external supplementary means and/or the inner components within the housing through the transparent cover or lens, an inner mass or bezel is placed at the base of the transparent cover or lens to cover those components.

The housing is configured so as to be sealed against water penetration, such as water run-off from other components of the vehicle, while being permeable to air to allow ventilation of the interior thereof. This ventilation is necessary due to the heat generated by the light source, which requires balancing the pressure between the inside and the outside of the housing. Such sealing and permeability of the housing are, for example, obtained by means of, for example, labyrinth baffles or other valves or apertures.

Vehicles are typically designed with a pair of headlamps and a pair of rear lamps. Condensation and ice buildup on the vehicle light assemblies is quite common. In the past, headlamps were based on incandescent bulb technology, an example being halogen bulbs. Halogen bulbs were placed within an enclosure having a cover and light generated by the bulbs was directed out through the cover. Halogen bulbs generate heat along with the light in the form of emitted radiation. Although generating some heat, this heat was not sufficiently effective to prevent the formation of condensation on the cover. To improve illumination efficiency one or more light-emitting diodes (“LED”) were designed to replace the halogen bulbs and other light sources. LEDs provide beneficial reduction in power consumption and generally last longer than other types of light sources, but do not generate sufficient heat to prevent the accumulation of condensation on the inside of the transparent cover or lens of the headlamp assembly. In addition, due to packing requirements and attempts to increase efficiency and aesthetics, the amount of air flowing through the headlamp enclosure has been substantially reduced. Therefore, substantial condensation issues exist, including not only the unsightly formation of condensation, but also the potential for reduced driver visibility. Similar issues have caused ice formation on the transparent covers or lenses of the headlamp assembly.

In the case of condensation, warmer air can hold more moisture than colder air, thus the combination of relatively warm moist air with a cooler surface tends to generate condensation on the cooler surface. While it is possible for condensation to form on many parts of the vehicle, condensation is most noticeable and aesthetically objectionable on transparent surfaces, such as the vehicle windshield and, for example, on the transparent cover or lens of the vehicle headlamps. Condensation tends to form on surfaces like the transparent cover or lens for the headlamps because interior air is relatively warm and moist while the transparent cover or lens itself on the outer surface is relatively cool due to the flow of cool exterior air over the transparent cover or lens. Once the relatively warm and moist interior air contacts the inner surface of the transparent cover or lens, it tends to cool and condense on the inside of the transparent cover or lens. Methods of controlling the formation of condensation (i.e., causing the condensation to evaporate) include lowering the level of moisture in the interior air, increasing the airflow across the inside surface of the transparent cover or lens and further heating the air.

Condensation of moisture on the transparent cover or lens is not desirable not only when the headlamp is in operation, but also when the vehicle is stopped and the light source is turned off. To prevent fogging of the glass cover, it was previously proposed to heat the glass cover by integrating in the glass cover heating elements such as resistors, electrode, heating film or the like. Unfortunately, such provisions have the disadvantage of altering the optical quality of the transparent glass cover or lens for projection of the light beam from the light source to induce an increase in the cost of inappropriate glass or transparent cover and lens and generate electrical consumption.

To avoid the use of the electrical energy, it was proposed to use the heat generated by the light source to heat the glass cover, as described in DE 10255443. A stream of hot air generated by the heat present in the chamber is directed towards the inner face of the transparent cover or lens so as to be scanned by the heat. Such provisions are unsatisfactory to the extent that their implementation is subject to the waste heat produced by the light source, and therefore, they may not be able to meet when the heat is inadequate or non-existent at all. Such a solution is more applicable to a restricted type of light source capable of producing sufficient heat, such as a discharge lamp or halogen lamp. In many cases with the light source utilizing LEDs, not enough heat is generated to provide sufficient hot airflow. In addition, the formation of passages of hot airflow through the mask prejudice to its primary function of having to hide the components of the headlamp assembly and therefore reduce the overall aesthetics of the headlamp.

Another approach to reducing moisture is shown in DE 10319363. A thermal electric unit is activated depending on weather conditions, including rain and outdoor temperatures. The use of the thermal active unit is satisfactory in view of the lower power consumption required for its implementation. However, such provisions of causing condensation in a dedicated area of the housing are insufficient to ensure preservation of reducing or elimination of ice and fog. These provisions do not allow for fast and efficient de-misting or de-icing and/or condensation removal and the prior implementation of the thermal electric unit does not meet users' expectations.

Existing solutions for de-icing and eliminating condensation to the transparent cover or lens to reduce the humidity inside the headlamp assembly are not satisfactory with regard to all requirements, including cost of obtaining and/or limiting operation of the device used, its small footprint in the overall headlamp assembly and of providing a de-icer that is effective to achieve quick condensation removal and de-icing that improves the overall operation of the headlamp assembly and perhaps provides improved visibility to the driver.

What is needed, therefore, is an assembly, system and method that facilitates reducing condensation and providing an assembly, system and method for de-icing a headlamp assembly.

### SUMMARY OF THE INVENTION

In one aspect, one embodiment of the invention comprises a headlamp and/or tail light assembly comprising a housing, an outer lens, a thermally conductive plastic situated in operative relationship with said outer lens, and a heating element for heating said thermally conductive plastic, wherein said thermally conductive plastic is situated a predetermined distance from said outer lens so that when said heating element is energized, said thermally conductive plastic becomes heated and causes heat to be directed towards said outer lens.

In another aspect, another embodiment of the invention comprises a heating element for use in a headlamp and/or tail lamp assembly comprising a thermally conductive plastic material overmolded onto the heating element or surrounding the heating element and adapted to be heated by the heating element so that when the heating element heats the thermally conductive plastic, the thermally conductive plastic may heat a component in the headlamp and/or tail lamp assembly.

This invention, including all embodiments shown and described herein, could be used alone or together and/or in combination with one or more of the features covered by one or more of the claims set forth herein, including but not limited to one or more of the features or steps mentioned in the following bullet list and the claims.

The headlamp and/or tail light assembly wherein the heating element is situated inside the thermally conductive plastic.

The headlamp and/or tail light assembly wherein the thermally conductive plastic is molded and comprises a longitudinal opening sized and adapted to receiving a mandrel and wire.

The headlamp and/or tail light assembly wherein the heating element is overmolded with the thermally conductive plastic.

The headlamp and/or tail light assembly wherein the thermally conductive plastic is molded into a predetermined shape adapted to be mounted into or on a component of the headlamp and/or tail light assembly.

The headlamp and/or tail light assembly wherein the predetermined shape comprises a plurality of heat fins in operative relationship with the out lens.

The headlamp and/or tail light assembly wherein the heat fins lie in a plate that is not parallel to the outer lens.

The headlamp and/or tail light assembly wherein the headlamp and/or tail light assembly comprises a bezel having a receiving area adapted and sized to receive the thermally conductive plastic.

The headlamp and/or tail light assembly wherein the headlamp and/or tail light assembly comprises a bezel having a receiving area for receiving the thermally conductive plastic such that the heating element is not visible after the bezel is mounted into the housing.

The headlamp and/or tail light assembly wherein the receiving area of the bezel is also adapted to receive at least one optical element in addition to the thermally conductive plastic.

The headlamp and/or tail light assembly wherein the at least one optical element is at least one of a light guide, a daytime running light or a lens.

The headlamp and/or tail light assembly wherein the thermally conductive plastic is molded in the predetermined shape that generally blends or is generally visually imperceptible from the at least one optical element.

The headlamp and/or tail light assembly wherein the predetermined shape comprises a predetermined aesthetic appearance that generally complements an appearance of at least a portion of a component in the headlamp and/or tail light assembly.

The headlamp and/or tail light assembly wherein the headlamp and/or tail light assembly comprises a bezel, the thermally conductive plastic being integral with the bezel.

The headlamp and/or tail light assembly wherein the heating element is overmolded with the thermally conductive plastic.

The headlamp and/or tail light assembly wherein the heating element is mounted on a mandrel and overmolded with the thermally conductive plastic.

The headlamp and/or tail light assembly wherein the mandrel comprises at least one helical or spiral channel or groove for receiving a wire adapted to fit in the at least one helical channel or groove.

The headlamp and/or tail light assembly wherein the mandrel comprises a plurality of helical or spiral channels or grooves for receiving a wire adapted and shaped to be received therein.

The headlamp and/or tail light assembly wherein the plurality of helical channels or grooves comprises a first helical or spiral channel or groove for directing the wire in a first direction of the mandrel and a second helical or spiral channel or groove for directing the wire in a second direction.

The headlamp and/or tail light assembly wherein the first helical or spiral channel or groove and the second helical or spiral channel or groove comprise different depths.

The headlamp and/or tail light assembly wherein the predetermined shape comprises a plurality of heat fins that are situated in operative relationship the predetermined distance from an inner surface of the lens.

The headlamp and/or tail light assembly wherein the heat fins lie in a plane that is angled a predetermined angle with respect to the outer lens.

The headlamp and/or tail light assembly wherein the predetermined distance is on the order of about 10.0 mm or less.

The headlamp and/or tail light assembly wherein the predetermined shape comprises a wall portion that is situated in operative relationship with the outer lens, the wall portion and an inner surface of the outer lens forming a predetermined angle with respect to the outer lens.

The headlamp and/or tail light assembly wherein the heating element comprises a mandrel for receiving and supporting the heating element.

The headlamp and/or tail light assembly wherein the mandrel is generally cylindrical and comprises at least one helical or spiral groove for receiving the heating element.

The headlamp and/or tail light assembly wherein the mandrel comprises a dual helical or spiral groove.

The headlamp and/or tail light assembly wherein the dual helical or spiral groove or channel comprises a first helical or spiral groove or channel describing a first orientation about the mandrel and a second helical or spiral groove or channel describing a second orientation, the first and second orientations being different.

The headlamp and/or tail light assembly wherein the first orientation is reverse relative to the second orientation.

The headlamp and/or tail light assembly wherein the heating element is a wire having a first conductive end and a second conductive end, the wire being received in both first helical or spiral groove or channel and the second helical or spiral groove or channel so that the first conductive end and the second conductive end extend or project from a common end or area of the mandrel.

The headlamp and/or tail light assembly wherein the headlamp and/or tail light assembly comprises a bezel comprising a bezel housing, the thermally conductive plastic being situated in operative relationship with the bezel housing to cause heat to be conducted to produce hot air that is circulated through the headlamp and/or tail light assembly to perform at least one of clearing condensation or de-icing the lens.

The headlamp and/or tail light assembly wherein the bezel housing comprises a first material having the thermally conductive plastic engaged to or integrally formed with the first material so that when the thermally conductive plastic is heated, heat is conducted through the first material to produce the hot air.

The headlamp and/or tail light assembly wherein the heating element is a wire molded into the thermally conductive plastic.

The headlamp and/or tail light assembly wherein the heating element comprises a wire mounted on a mandrel and overmolded with the thermally conductive plastic.

The headlamp and/or tail light assembly wherein the heating element comprises a wire mounted on a mandrel, the thermally conductive plastic defining a housing having a receiving opening for receiving and housing the mandrel and wire.

The headlamp and/or tail light assembly wherein the mandrel is generally cylindrical and comprises at least one helical or spiral groove or channel for receiving the heating element.

The headlamp and/or tail light assembly wherein the mandrel comprises a dual helical or spiral groove.

The headlamp and/or tail light assembly wherein the dual helical or spiral groove or channel comprises a first helical or spiral groove or channel describing a first orientation about the mandrel and a second helical or spiral groove or channel having a second orientation, the first and second orientations being different.

The headlamp and/or tail light assembly wherein the first orientation is reverse relative to the second orientation.

The headlamp and/or tail light assembly wherein the heating element is a wire having a first conductive end and a second conductive end, the wire being received in both first helical or spiral groove or channel and the second helical or spiral groove or channel so that the first conductive end and the second conductive end extend or project from a common end or area of the mandrel.

The headlamp and/or tail light assembly wherein the heating element is coupled to a microcontroller that determines whether or not a de-icing mode or a condensation removal mode should be performed, and performs at least one of the de-icing mode or the condensation removal mode in response to the determination made, wherein during the de-icing mode, the microcontroller causes a power source to energize the heating element for a predetermined de-icing period of time at a predetermined de-icing temperature, and during the condensation removal mode, the microcontroller causes the power source to energize the heating element for a predetermined condensation removal period of time at a predetermined condensation removal temperature.

The headlamp and/or tail light assembly wherein the predetermined de-icing period of time and predetermined de-icing temperature are less than the predetermined condensation removal period of time and predetermined condensation removal temperature, respectively.

The heating element wherein the heating element is overmolded with the thermally conductive plastic and situated in a bezel used in the headlamp and/or tail lamp assembly.

These and other objects and advantages of the invention will be apparent from the following description, the accompanying drawings and the appended claims.

### BRIEF DESCRIPTION OF THE ACCOMPANYING DRAWINGS

FIG. 1 is a plan view of a headlamp and/or tail lamp assembly in accordance with one embodiment of the invention;

FIGS. 2 and 3 are exploded views of the headlamp and/or tail lamp assembly shown in FIG. 1;

FIGS. 4A-4C are various perspective views of a bezel having a heater in accordance with one embodiment of the invention mounted thereon;

FIG. 5 is a sectional view taken along the line 5-5 in FIG. 1;

FIG. 6 is another sectional view of the headlamp and/or tail lamp assembly shown in FIG. 5;

FIG. 7 is another view of the heater of shown in FIGS. 2 and 3 showing a mandrel, heating element and overmolded thermally conductive plastic;

FIGS. 8A-8E are various views of the mandrel and heating element and overmolded thermally conductive plastic;

FIG. 9 is another view of the heater in accordance with one embodiment of the invention;

FIGS. 10A and 10B illustrate an embodiment with thermally conductive plastic overmolded directly onto a heating element and without the use of a mandrel or support;

FIGS. 11-15 illustrate other embodiments and configurations of the thermally conductive plastic and heater in accordance with other embodiments of the invention; and

FIG. 16 is a schematic view of the heater control logic used with one embodiment of the invention.

### DETAILED DESCRIPTION OF THE PREFERRED EMBODIMENTS

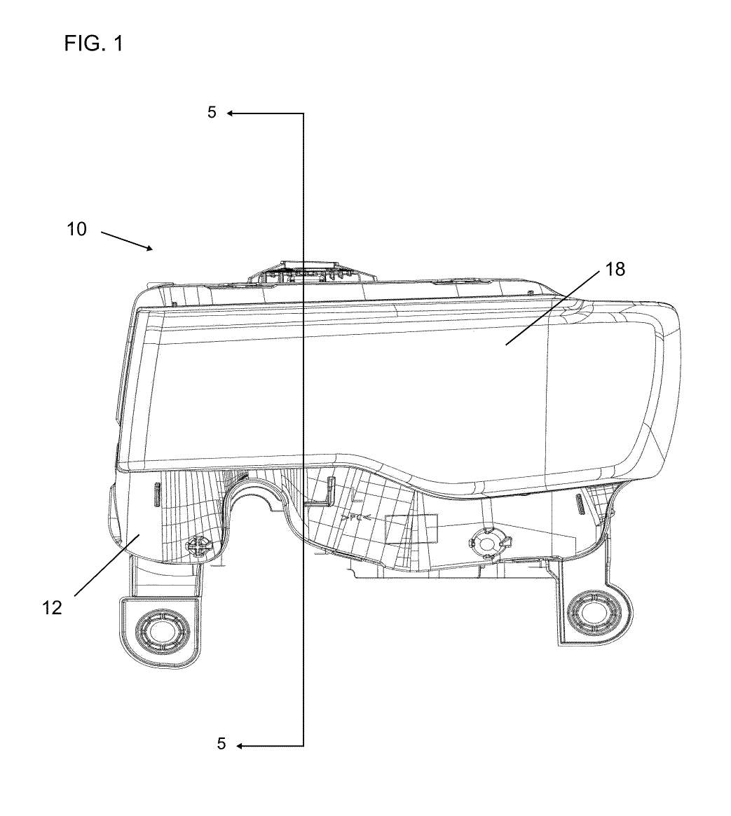

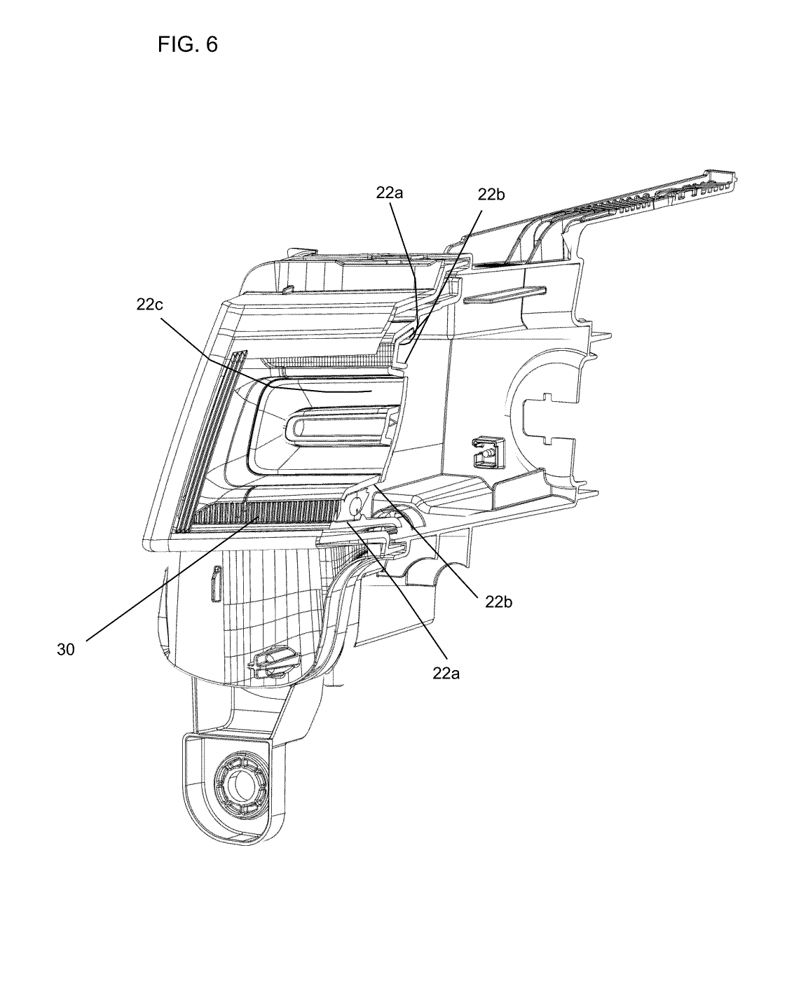

Referring now to FIGS. 1-15, a headlamp and/or tail lamp assembly, system and method are shown. The headlamp and/or tail lamp assembly 10 comprises a housing 12 having a reflector 14, at least one light source 16 and an outer lens 18, all of which are conventionally mounted therein. In the illustration being described, the features of the embodiment being described may be used in a lighting and/or signaling device, such as a headlamp or a tail lamp on a vehicle. In the illustration being described, the at least one light source 16 may comprise one or more conventional light-emitting diodes (LEDs) which are operatively mounted in proximity to the reflector 14 in order to reflect light from the at least one light source 16 and, ultimately, through the outer lens 18 in a manner conventionally known.

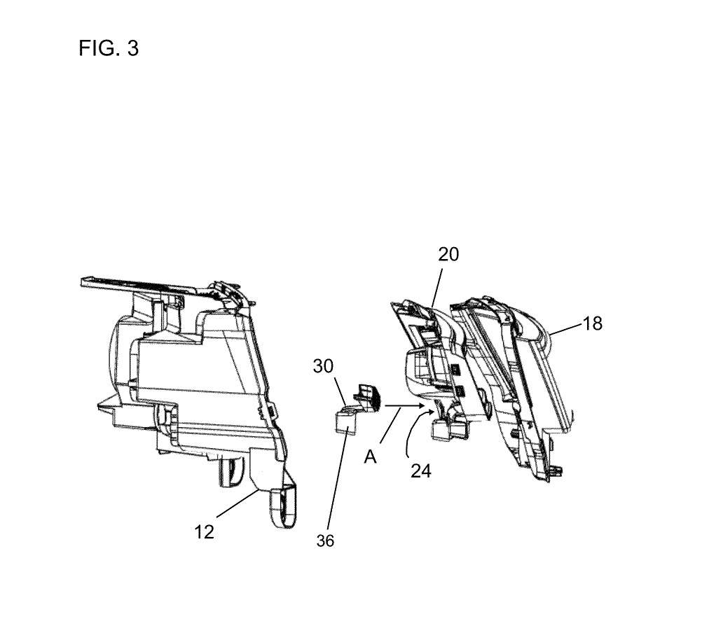

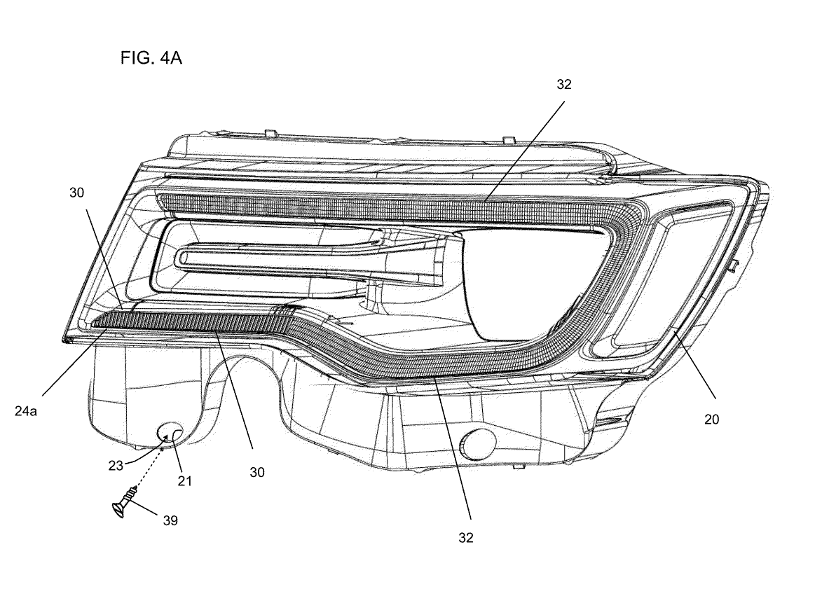

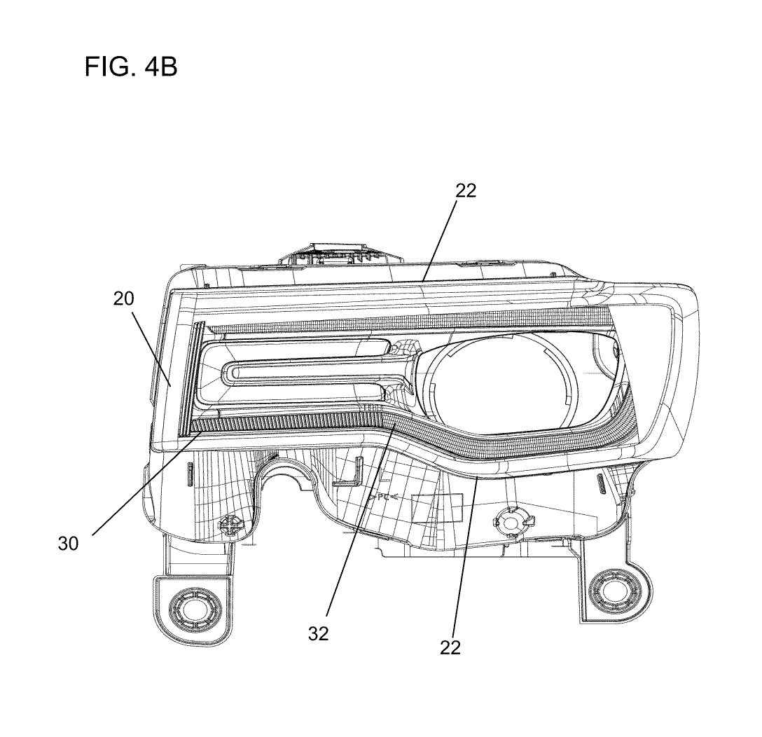

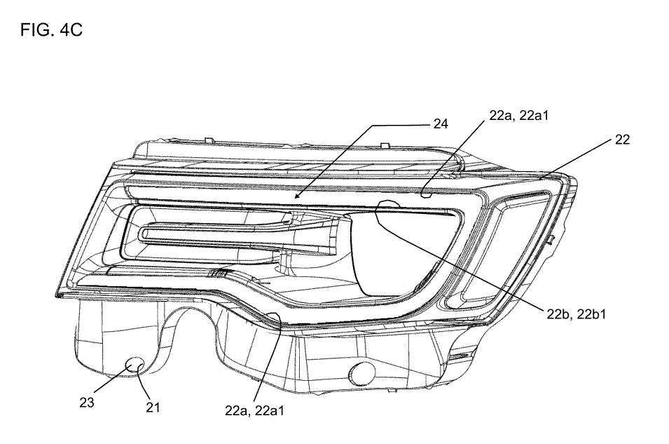

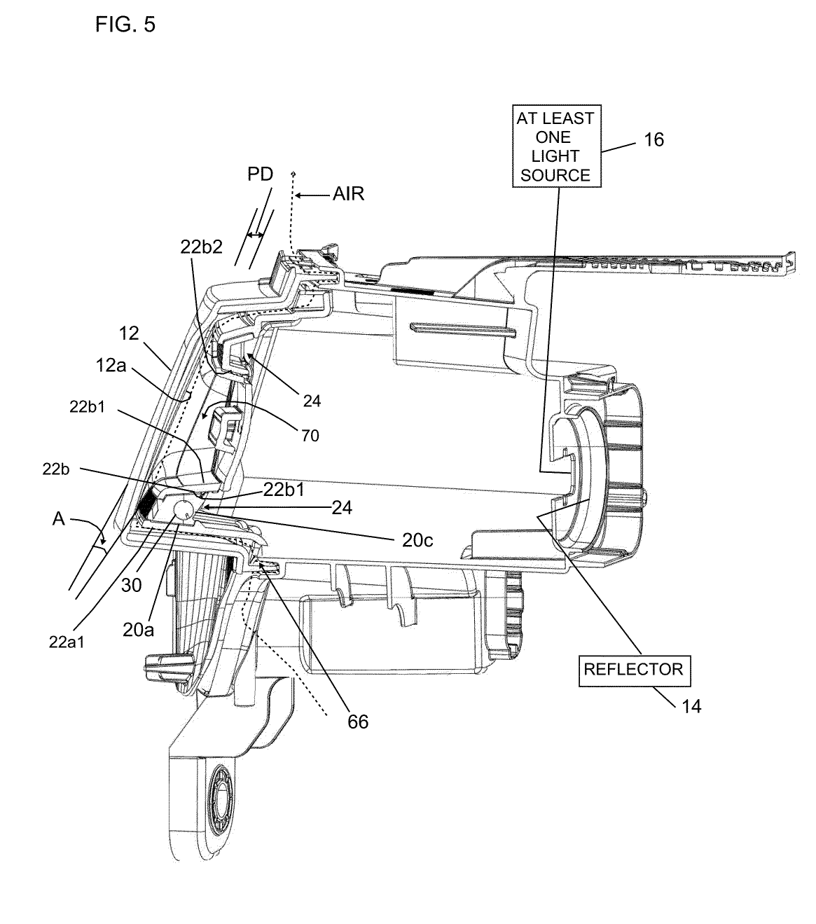

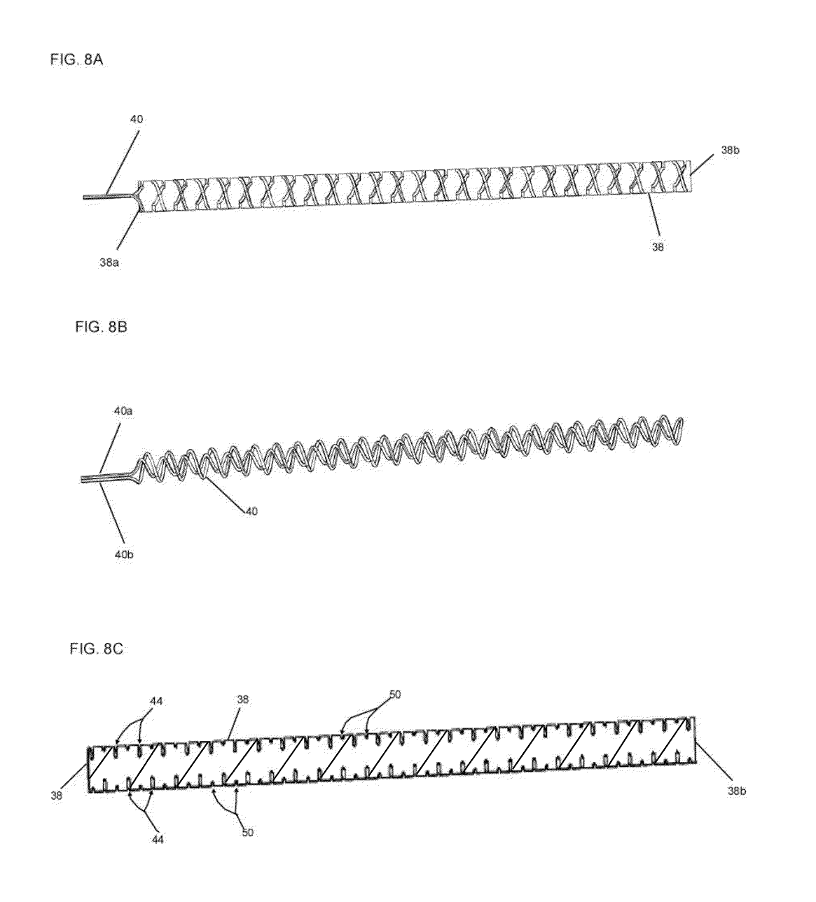

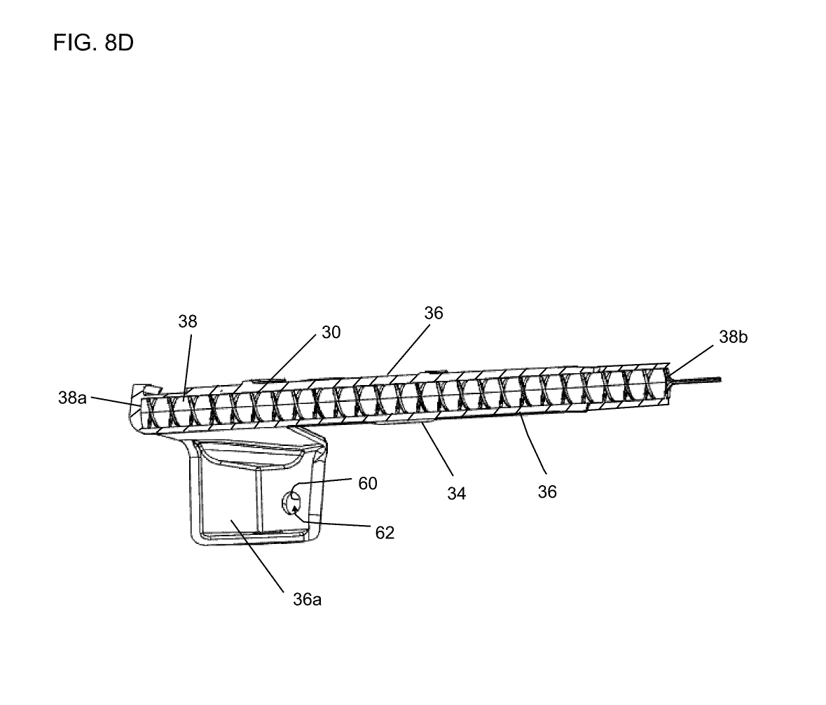

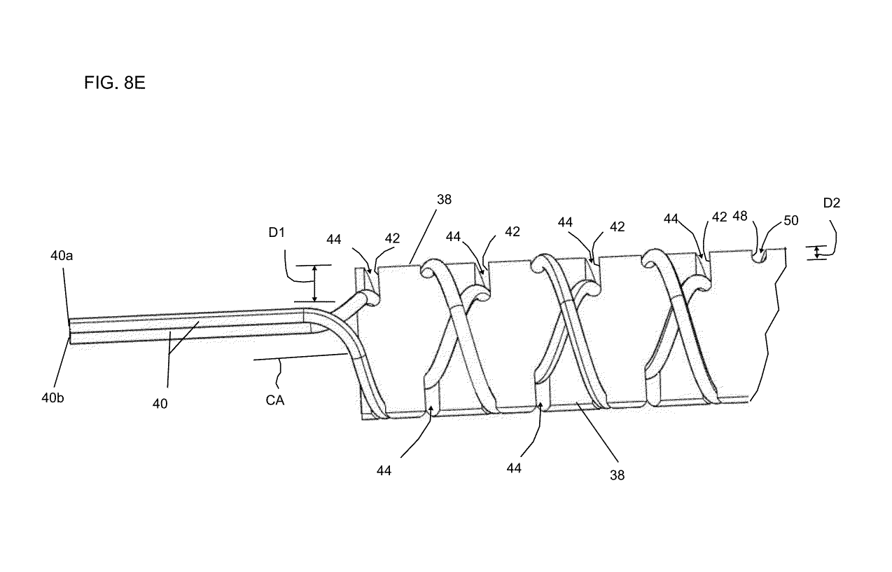

The headlamp and/or tail lamp assembly 10 further comprises a bezel 20 that is conventionally mounted on the housing 12 with suitable fasteners, such as screws (not shown). The bezel 20 comprises a first wall 22a and a generally opposing second wall 22b, which are shown in cross-section as best illustrated in FIGS. 5-7. The first and second walls 22a and 22b are situated about at least a portion of the bezel 20, such as a periphery of bezel 20, as shown in FIGS. 5-7. In the illustration being described, the first and second walls 22a and 22b cooperate to define a receiving area 24 (FIGS. 3, 4C and 5) that receives a heater 30 and is also adapted to receive at least one or a plurality of optical components, such as a daytime running light (DRL), a light guide or the like. Thus, it should be appreciated that the receiving area 24 is adapted to support multiple optical components, along with the heater 30. Note, for example, in FIGS. 4A-4C, the receiving area 24 is adapted to receive a conventional daytime running lamp (DRL) or light guide 32 which is situated in the receiving area 24 adjacent to the heater 30. In one illustrative embodiment and as described later, the heater 30 is molded and formed to look like the other optical components that are mounted in the receiving area 24 so that there is visually no perceptible transition between the various components, as shown in FIG. 4A. It has been found that this is cosmetically advantageous, especially when the other optical components are not active, such as, for example, during the daytime when the other optical components may not be active. Advantageously, this makes the heater 30 visually indistinct from the other components that may be received in the receiving area 24. FIGS. 8A-8D illustrate features of the heater 30 which will now be described.

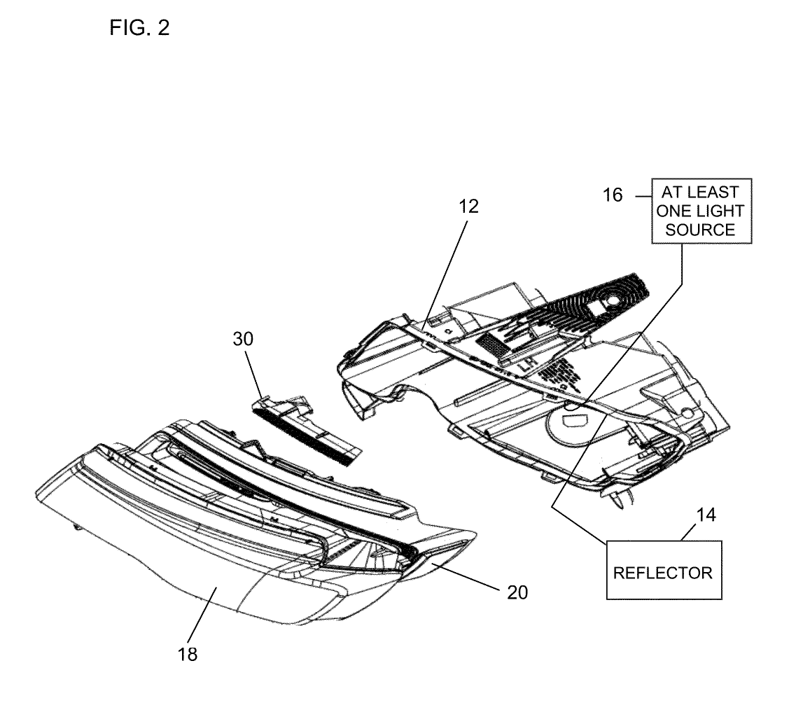

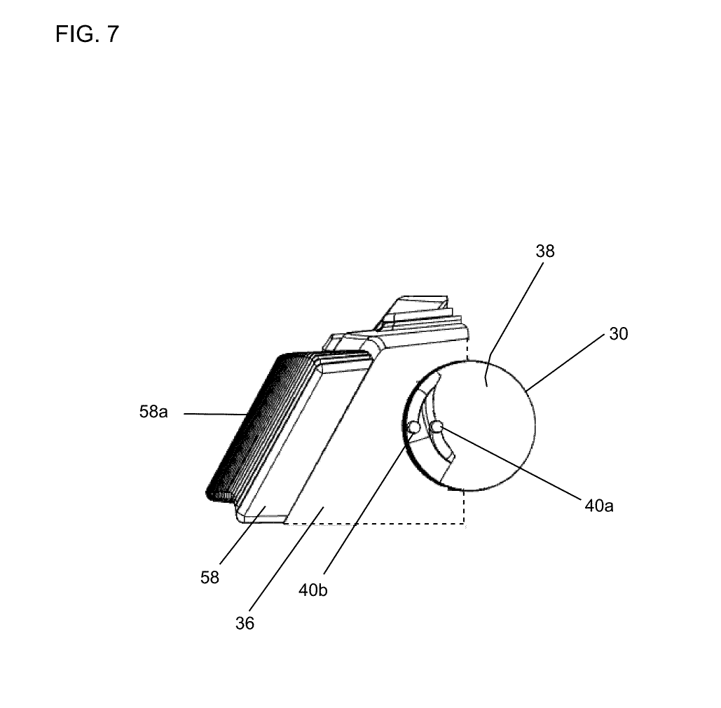

The heater 30 comprises a thermally conductive plastic (TCP) material, such as the thermally conductive polymer available from Cool Polymers, Inc. of North Kingstown, R.I., that is formed or molded into a predetermined shape, such as the shape illustrated in FIGS. 2, 7 and 8D. In the illustration being described, the predetermined shape of the thermally conductive material is sized and adapted to be received in the receiving area 24 defined by the first and second walls 22a and 22b. Thus, it should be understood that one feature of the embodiment being described is that the thermally conductive plastic (TCP) is molded into the predetermined shape and is adapted to fit in the receiving area 24 so that it generally blends or becomes generally visually imperceptible from the at least one optical element, such as the DRL or light guide 32, that is also mounted in the bezel 20. Referring back to FIGS. 4A-6, note that the thermally conductive plastic (TCP) is molded into the predetermined shape which fits generally snugly in the lower left hand portion 24a (as viewed in FIG. 4A-4C) of the receiving area 24, with the remainder of the receiving area 24 being consumed by the other optical components, such as the DRL or light guide 32 mentioned earlier. Note that the thermally conductive plastic (TCP) is formed into a housing 36 (FIGS. 7 and 8D) having a flange 36a for mounting the heater 30 onto the headlamp or tail lamp assembly housing 12 with a conventional screw 39 (FIG. 4A).

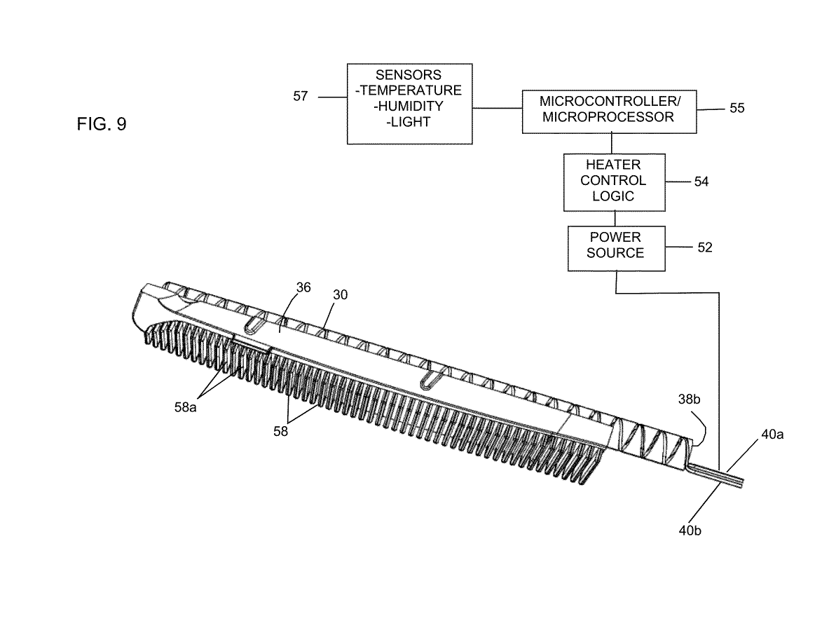

For ease of illustration, FIGS. 7 and 9 shown the heater 30, mandrel 38 and heating element only partially overmolded so that details of the heater 30 may be seen. In a preferred embodiment, the heater 30 is entirely overmolded in the housing 36.

In one embodiment, the heater 30 comprises a heating mandrel 38 having a heating element 40 mounted thereon. The heating mandrel 38 and heating element 40 are at least partially (FIG. 7) or wholly (FIG. 3) overmolded with the thermally conductive plastic (TCP). Thus, in one illustrative embodiment, the mandrel 38 and a heating element 40 are overmolded with the thermally conductive plastic (TCP) as illustrated in FIGS. 2, 3 and 5-7. In one embodiment, the heating element 40 is a conventional conductive copper wire.

Alternatively, the thermally conductive plastic (TCP) can be molded with an elongated receiving area or hollow area (not shown) that is sized and adapted to receive the mandrel 38 and heating element 40.

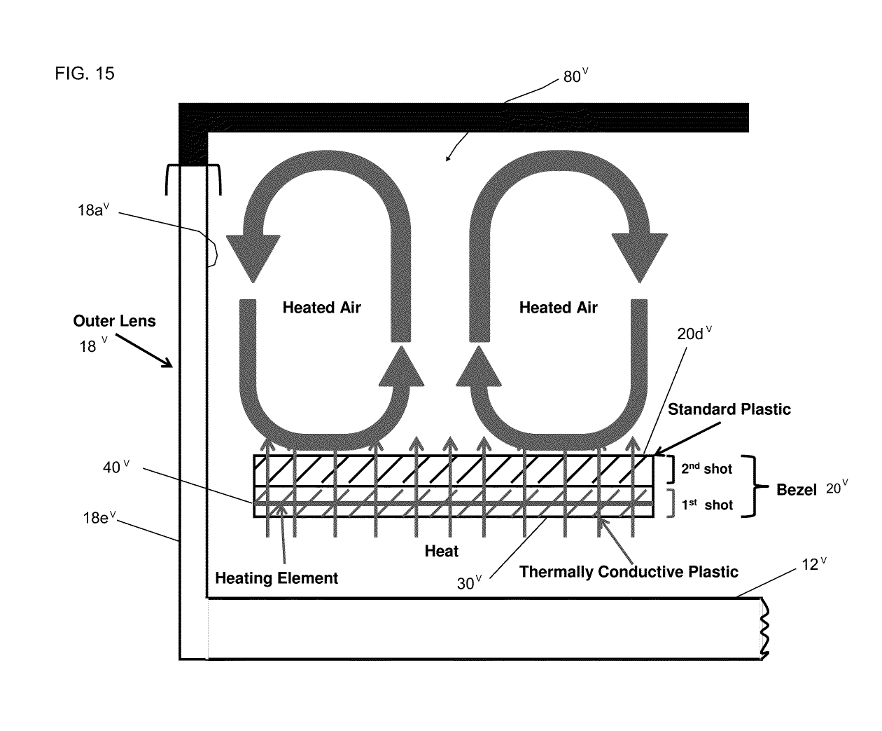

As illustrated in FIGS. 5-8E, the mandrel 38 comprises a first wall 42 that extends from a first end 38a to a second end 38b as illustrated in FIGS. 14 and 15B. The first wall 42 defines a first helical or spiral channel or groove 44. The mandrel 38 also comprises a second wall 48 which defines a second helical spiral channel or groove 50. note that the mandrel 38 comprises at least one or a plurality of helical or spiral channels or grooves 44 and 50 (FIG. 8C) for receiving the heating element 40 which is generally complementary-shaped so that at least a portion of the heating element 40 can be received in at least one helical or spiral channel or groove. The first and second walls or grooves 44 and 50 are generally U-shaped in cross-section as shown. Note that the first and second helical spiral channels or grooves 44 and 50 extend in opposite directions or orientations and their respective helical or spiral form are generally reversed from each other. In one embodiment, the mandrel 38 comprises a dual helix or spiral having the first helical or spiral channel or groove 44 that describes a first orientation about the mandrel and the second helical spiral channel or groove 50 that describes a second orientation, wherein the first and second orientations are different. Again, notice in FIGS. 8A and 8C that the orientations are reversed from each other. This is advantageous in that the heating element 40 comprises a first end 40a and a second end 40b that extend from a common end, such as end 38b, of mandrel 38.

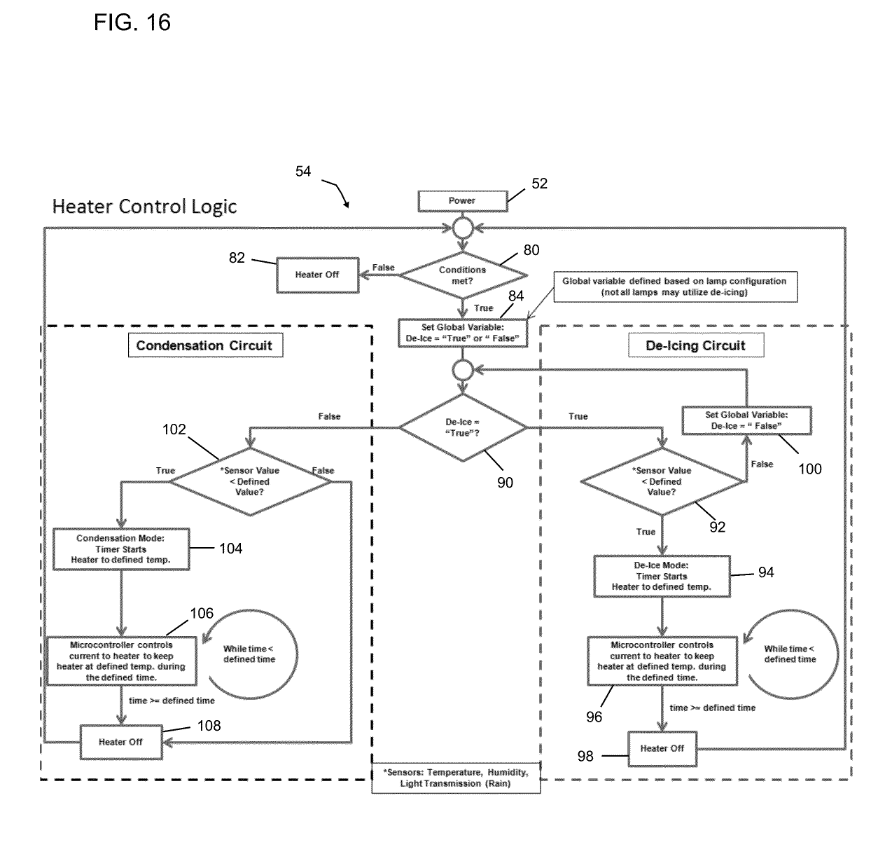

The first and second ends 40a and 40b are coupled to a power source 52 that is under the control of heater control logic 54 that is described later. In this regard, the headlamp and/or tail lamp assembly 10 further comprises a microprocessor or microcontroller 55 (FIG. 9) that executes the heater control logic 54 via computer instructions (not shown) embedded in read-only memory (not shown) associated with the microcontroller or microprocessor 55. Various sensors 57 may also be utilized by the microprocessor or microcontroller 55 to control the power or current applied by the power source 52 to provide a predetermined amount of heat to the thermally conductive plastic (TCP) for a predetermined period of time, both of which will be described later herein. The heater control logic 54 will be described in more detail later herein relative to FIG. 16. In one embodiment, the sensors 57 may be at least one of a temperature, humidity or light sensor.

Returning to FIGS. 14-16, the first and second ends 40a, 40b extend from the end 38b of mandrel 38 where they can be connected to the power source 52. In one illustrative embodiment, the power source 52 may be a conventional lighting harness (not shown) associated with the headlamp and/or tail lamp assembly 10.

In order to maintain separation of the heating element 40 so that it does not short circuit as current travels between the ends 40a and 40b, the first helical spiral channel or groove 44 comprises a depth D1 (FIG. 8E) that is deeper than a depth D2 of the second helical spiral channel or groove 50. Thus, the second helical spiral channel or groove 50 comprises the depth D2 that is shallower than the depth D1 mentioned earlier. Consequently, the heating element 40 is seated lower and closer to a center axis CA (FIG. 16) of the mandrel 38 so that it is interior with respect to a portion of the heating element 40 that is situated in the second helical spiral channel or groove 50 as best illustrated in FIG. 8E.

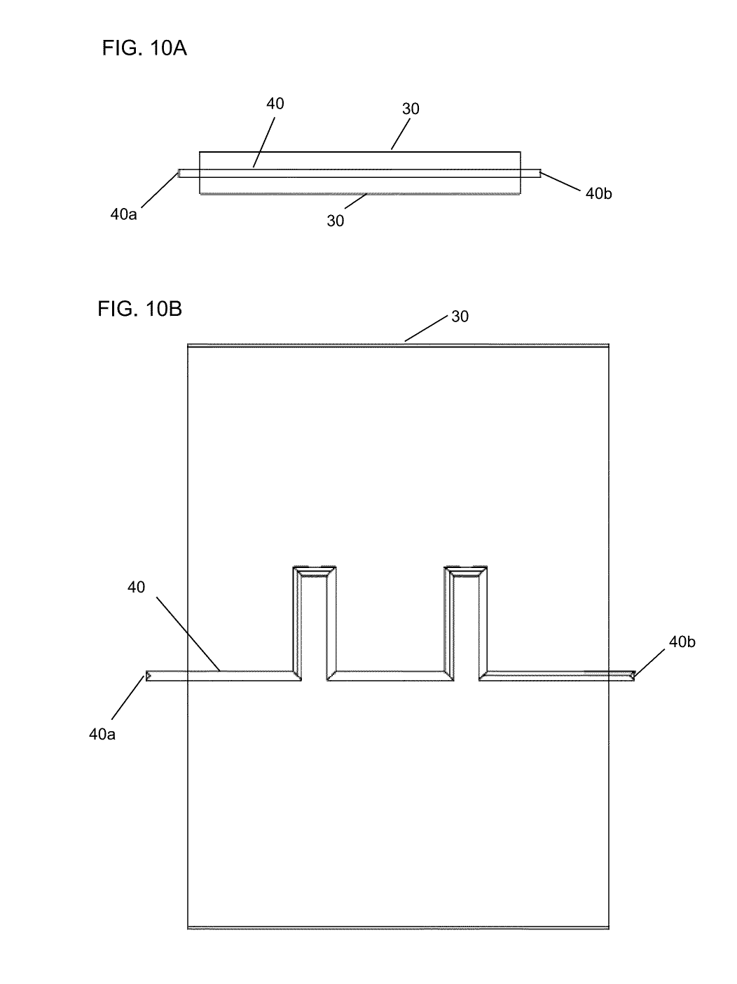

FIGS. 1-9 illustrate an embodiment of the thermally conductive plastic (TCP) overmolded over at least part of the mandrel 38 and heating element 40. In contrast, FIGS. 10A and 10B illustrate another embodiment of the heater 30 wherein no mandrel is used and the heating element 40 is overmolded directly with the thermally conductive plastic (TCP). FIG. 10B shows the overmolded heating element 40 in a serpentine shape to facilitate providing more heat to the thermally conductive plastic (TCP) when the heating element 40 is energized.

In general, the heater 30 comprises the thermally conductive plastic (TCP), the mandrel 38, heating element 40 and the heater 30, which are inserted into the receiving area 24 of the bezel 20 in the direction of arrow A in FIG. 3. Note that the thermally conductive plastic (TCP) is formed or molded with the flange 36a (FIG. 8D) mentioned earlier herein. Note that the flange 36 has an interior wall 60 that defines an aperture 62 that mates with a corresponding aperture 23 (FIG. 4A) defined by an interior wall 21 in the bezel 20 so that the screw 39 can be inserted therethrough and to secure the bezel 20 and heater 30 together and to the housing 12. The outer lens 18 and other components of the headlamp and/or tail lamp assembly 10 are then mounted on the housing 12.

Referring to FIG. 5, when the heater 30 is energized by the power source 52, air that is received in a channel or passageway 66 travels along the path (labeled AIR in FIG. 5). The first wall 20a of the bezel 20 comprises a first generally planar surface or wall portion 22a1 that is generally opposed to a second generally planar surface or wall portion 22b1. These walls 20a and 20b cooperate to define the channel or area 24 as mentioned earlier. When the heater 30 is energized, the heating element 40 heats the thermally conductive plastic (TCP) that forms the housing 12 and that heat is transmitted to the generally planar surfaces or wall portions 22a1 and 22b1. This creates a convection current that travels upward (as viewed in FIG. 5) along the pathway 66 indicated by the arrow labeled “air”. Note that the heat fins 58 comprise edges 58a that become positioned and generally opposed in operative relationship relative to the inner surface 18a of the outer lens 18 as best illustrated in FIG. 5. As air travels from underneath the first generally planar surface or wall portion 22a1 of the bezel 20, it begins to get heated by heated by the heater 30. The air travels upward (as viewed in FIG. 5) and across the heat fins 58 which further heats the air passing through the headlamp and/or tail lamp assembly 10. The heated air travels further upward across the inner surface 18a of the outer lens 18, thereby facilitating de-icing or removing condensation from the outer lens 18.

Note that the wall portion 22b1 of the bezel 20 is slanted generally upward towards the inner surface 18a of outer lens 18. The edges 58a are situated a predetermined distance from the inner surface 18a of the outer lens 18. In this example, the predetermined distance is equal to or less than about 10.0 mm. Note that the bezel 20 has a wall 22c that cooperate with wall portions 22a1 and 22a2 to define a heating area 70 which facilitates capturing and heating the air as it passes through the passageway 66 (FIG. 5). In this regard, note that the first wall 22a, along with the heating fins 58, define a generally L-shaped portion 66a of the passageway 66 that begins underneath the bezel 20 and extends generally horizontally and relative to the outer lens 18 until it turns upward as viewed in FIG. 5 where the air can pass by the heating fins 58 and become further heated and ultimately travel upward and across the inner surface 18a of the outer lens 18 and, ultimately, out the headlamp and/or tail lamp assembly 10 as illustrated in the FIG. 5. This, in turn, de-ices the outer lens 18 or eliminates condensation on the outer lens 18.

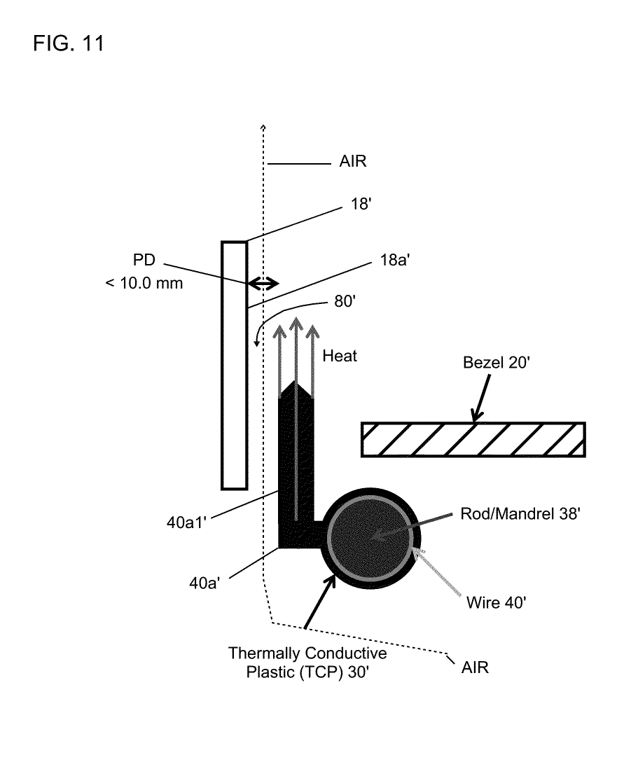

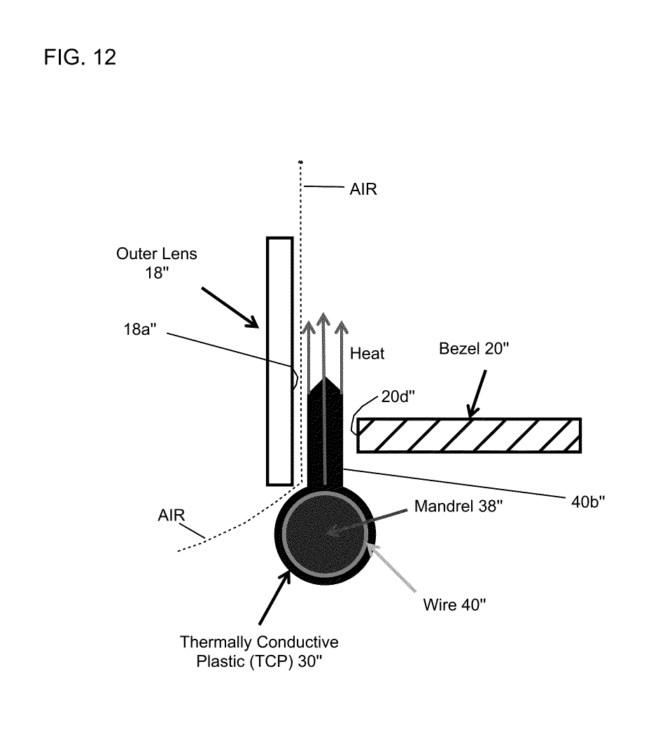

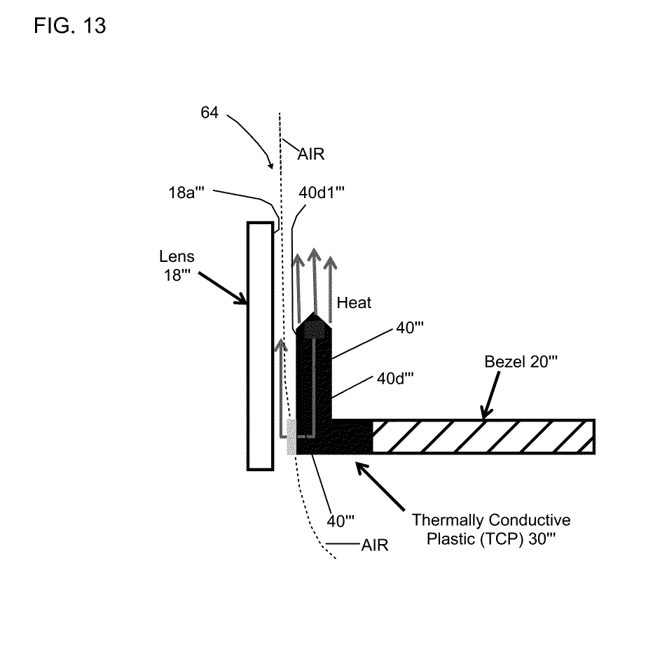

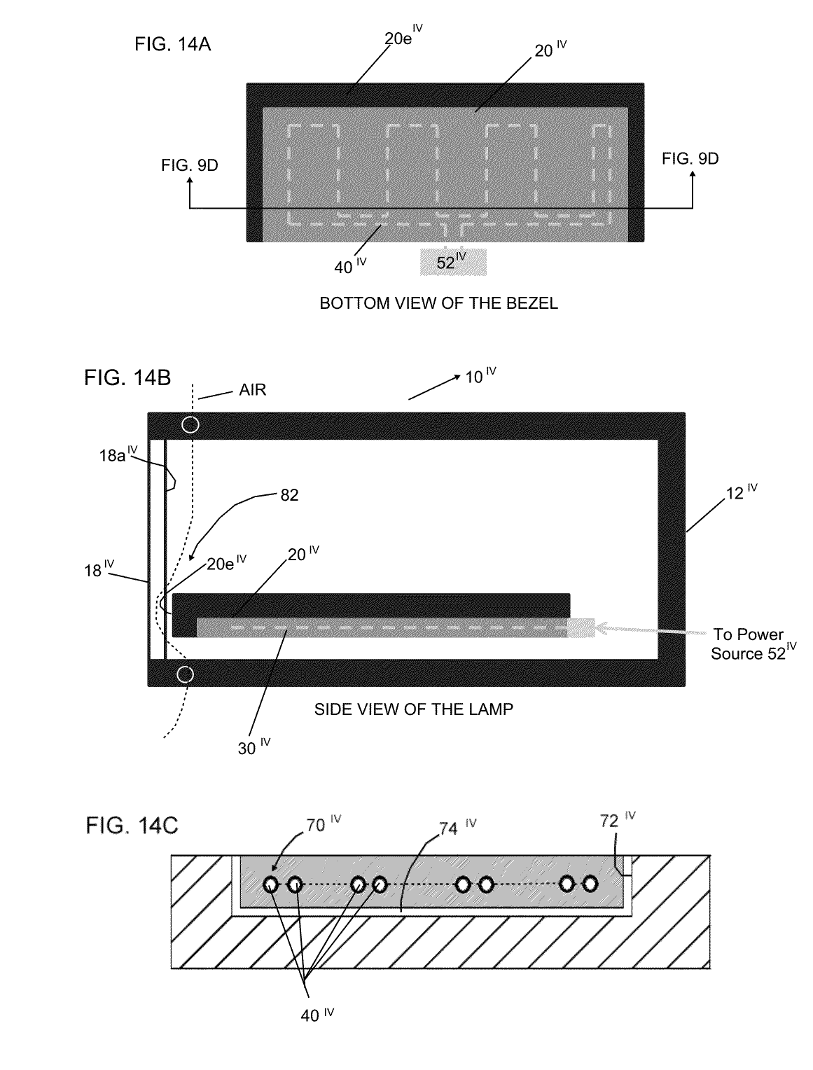

Referring now to FIGS. 11-16, general schematic diagrams illustrating various features of other embodiments are shown. For ease of illustration, the FIGS. 7-9D are provided in a schematic format with various components, such as the housing 12, at least one light source 16, reflector 14 and the like being removed to facilitate understanding the features of these embodiments. In these embodiments, like parts are identified with the same part numbers, except that prime marks or roman numerals (′(FIG. 11), ″(FIG. 12), ′″(FIG. 13), ^{IV}(FIG. 14A-14C) or ^{V}(FIG. 15)) have been added to the part numbers in FIGS. 11-15.

In the embodiment in FIG. 11, the thermally conductive plastic (TCP) is molded into the predetermined shape which in this embodiment comprises a generally L-shaped arm 40a′ that has a portion 40a1′ that extends generally upward (as viewed in FIG. 11) and generally parallel to the inner surface 18a′ of the outer lens 18′ so that heated air may pass between the portion 40a1′ and the inner surface 18a′. As mentioned earlier herein, the inner surface 18a′ is separated from the portion 40a1′ by the predetermined distance PD which in the illustration is on the order of about 10.0 mm or less. Thus, as mentioned earlier herein relative to the prior embodiments, the thermally conductive plastic (TCP) may be molded into a predetermined shape having at least a portion, such as portion 40a1′, that becomes situated in proximity to the bezel 20′ and that defines a passageway or channel, such as the passageway labeled 80 in FIG. 11, to facilitate heating the air that passes between the portion 40a1′ of the thermally conductive plastic (TCP) and the inner surface 18a′ of the outer lens 18′.

In still another embodiment shown in FIG. 12, note that the thermally conductive plastic (TCP) may be formed to provide a linear projection 40b″ that becomes operatively disposed between a surface. As with the embodiment shown in FIG. 11, in this embodiment the projection 40b″ extends generally parallel to the inner surface 18a″ of the outer lens 18″ as shown.

The embodiments described earlier herein illustrated a heater 30 or thermally conductive plastic (TCP) separately formed and mounted onto or in the bezel 20 of the headlamp and/or tail lamp assembly 10. It should be understood that the heater 30 could be mounted to other components in the headlamp and/or tail lamp assembly 10, such as on or near the outer lens 18. Moreover, it is contemplated that the thermally conductive plastic (TCP) may be integrally molded or overmolded onto at least a portion of the bezel 20 or, alternatively, onto other components in the headlamp and/or tail lamp assembly 10. FIGS. 13-15 illustrate these concepts.

In this regard, FIG. 13 illustrates the bezel 20′″ having the thermally conductive plastic (TCP) integrally molded or formed thereon and in proximate relationship with the inner surface 18a′″ of the outer lens 18′″ as shown. Similar to the embodiment shown and described earlier herein relative to FIG. 10A, in this embodiment a conductor, such as the heating element 40′″, may be integrally molded in the thermally conductive plastic (TCP) as shown. In the illustration being described in FIG. 10B, the thermally conductive plastic (TCP) is molded into the predetermined shape to comprise a general L-shape having a generally vertically extending portion 40d′″ that extends generally vertically upward (as viewed in FIG. 9A) and has a surface 40d1′″ that becomes generally opposed to the inner surface 18a′″ of the outer lens 18′″ and cooperates with that inner surface 18a′″ to define a passageway 64 so that air passing into and through the passageway 64 becomes heated similar to the other embodiments.

FIGS. 14A-14C illustrate another embodiment wherein the thermally conductive plastic (TCP) is overmolded onto one or more of the components of the headlamp and/or tail lamp assembly 10^{IV}. In this illustration, note that the headlamp housing 12^{IV} has the outer lens 18^{IV} mounted thereon and the bezel 20^{IV} has the thermally conductive plastic (TCP) molded directly to the bezel 20^{IV}. In this regard, note that the bezel 20^{IV} comprises a generally U-shaped open cavity or area 70^{IV} that is defined by a generally U-shaped wall 72^{IV} and a surface 74^{IV} that cooperate to form a generally U-shaped cavity. In the illustration shown in FIG. 14B, note that the cavity or area 70^{IV} is formed with the thermally conductive plastic (TCP) and comprises the heating element 40^{IV} that is overmolded with the thermally conductive plastic (TCP) and coupled to the power source 52^{IV}. The bezel 20^{IV} is situated in the housing 12^{IV} of the headlamp and/or tail lamp assembly 10^{IV} as illustrated in FIG. 14A. The portion 20e^{IV} (FIG. 14B) of the bezel 20^{IV} becomes generally opposed to the inner surface 18a^{IV} to provide a passageway or channel 82 of the outer lens 18^{IV} so that air can pass into the housing 12^{IV} and generally upward as shown in FIG. 14B. In this regard, when the power source 52^{IV} is energized, the thermally conductive plastic (TCP) is heated which in turn heats the material forming the bezel 20^{IV}. The heat from both rises to cause a convection current which causes heated air to pass through the passageway or channel 82 across the inner surface 18a of the outer lens 18.

FIG. 15 illustrates still a further embodiment showing another bezel 20^{V}. In this embodiment, a dual shot or dual-plate bezel 20^{V} embodiment is provided wherein a first shot is molded from the thermally conductive plastic (TCP) having a heating element 40^{V} that is integrally molded therein. This shot of thermally conductive plastic (TCP) is overmolded onto or affixed to a standard bezel plastic material which in the illustration being described is generally planar to provide at least a portion of the bezel 20^{V}. In the illustration being described, it should be understood that the portion 20d^{V} of the bezel 20^{V} has the thermally conductive plastic (TCP) overmolded or molded thereto. In this illustration, the portion 20d^{V} is generally planar and is situated towards a bottom area 18e^{V} of the outer lens 18^{V}. Note that when the thermally conductive plastic (TCP) is heated to a predetermined temperature by energizing the heating element 40^{V}, the heat generates a convection current as illustrated in FIG. 15. The convection current provides heat in the area 80^{V} defined by the housing 12^{V} to facilitate heating the inner surface 18a^{V} of the outer lens 18^{V} to facilitate de-icing the outer lens 18^{V} and/or reducing condensation thereon.

Advantageously, the various embodiments shown and described herein illustrate the use of the thermally conductive plastic (TCP) that may be used alone or in combination with components of the headlamp and/or tail lamp assembly 10, such as the bezel 20, in order to heat those components or to provide heat to the inner surface 18a of the outer lens 18 in order to facilitate reducing or eliminating condensation and to de-ice the outer lens 18.

As mentioned earlier herein, it has been found that situating such heated surfaces approximately 10.0 mm or less from the inner surface 18a of the outer lens 18 is desirable, and preferably, the power source 52 energizes the heating element 40 to heat the thermally conductive plastic (TCP) to at least 90 degrees Celsius.

In still another aspect or embodiment of the invention, the heater control logic 54 for controlling the power source 52 and the heat generated by the heating element 40 will now be described relative to FIG. 16.

Referring now to FIG. 16, the heater control logic 54 begins at decision block 80 where it is determined whether or not a call for condensation removal or de-icing is requested or conditions are met. If neither mode is called for, then the heater 30 remains off as indicated at block 82. If conditions are met, then either de-icing or condensation removal has been requested. Initially, a global variable is set and defined based upon the headlamp configuration. For example, some headlamp assemblies may not include or utilize de-icing. In one illustrative embodiment, a de-icing variable is initially set to true or false.

It should be understood that the de-icing circuit is indicated by the dashed lines 86 to the right of FIG. 16 and the condensation circuit is indicated by the dashed lines to the left of FIG. 16. At decision block 90 it is determined whether the de-icing variable is true, and if it is, the routine proceeds to decision block 92 where it is determined whether or not a sensed value is less than a defined value. In this regard, the at least one sensor 57 (FIG. 5) provide one or more sensed signals or sensed values. For example, the sensed signals or sensed values could be a sensed temperature, a sensed humidity or a sensed light transmission, which may be impacted by rain. Light transmission can be used to detect a condensation event as with rain sensing wipers. If the sensed value is less than a corresponding predefined value, then the microcontroller 55 causes the power source 52 to energize the heater 30 to a de-icing mode. During this de-icing mode, the heating element 40 is energized to a predetermined de-icing temperature, such as 120 degrees Celsius, for a predetermined de-icing time. It should be understood that the heater control logic 54 is defined by computer instructions resident on a conventional microprocessor or microcontroller 55 adapted to execute the computer instructions. The microprocessor or microcontroller 55 continues energizing the heater 30 at the predetermined de-icing temperature for the predetermined de-icing time at decision block 96. Once the microprocessor or microcontroller 55 times out and the actual time exceeds the predetermined de-icing time, the microprocessor or microcontroller 55 turns the heater 30 off (block 98) and the routine loops back to decision block 80 as shown.

If the decision at decision block 92 is false, then the global variable for the de-ice mode is set to false at block 100 and the routine loops back to decision block 90. In this situation, the de-ice decision is true because the de-ice variable was set to false at block 100 the routine will loop to the condensation circuit 88. At decision block 102 it is determined whether the sensed value is less than the defined value and if it is then a condensation removal mode is begun at block 104. In this regard the microprocessor or microcontroller 55 energizes the heating element 40 of the heater 30 for a condensation removal mode and begins a timer.

At block 106, the microprocessor or microcontroller 55 controls the current to the heater 30 to keep the heater 30 at a defined condensation removal temperature during the predetermined or defined time and while the actual time is less than the predetermined or defined condensation removal time. Once the actual time is equal to or exceeds the predetermined or defined condensation removal time, the microprocessor or microcontroller 55 turns the heater 30 off at block 108 and the routine loops back to decision block 80 as shown. If the decision at decision block 102 is false, then the sensed value is less than a defined sensed value and the routine loops to block 108 where the heater 30 either remains off or is turned off.

Advantageously, the headlamp and/or tail lamp assembly 10 comprises the heater control logic 54 adapted to control the power to the heating element 40 and the duration of energizing the heating element 40 in order to heat the outer lens 18 in order to perform at least one of a de-icing of the outer lens 18 or removal of condensation from the outer lens 18. In this regard, it should be understood that the predetermined de-icing temperature during the de-icing mode is about <0 degrees Celsius and the predetermined de-icing time is about ten minutes when the heating element 40 is energized for approximately 15-20 minutes. In contrast, during the condensation removal mode, the predetermined condensation removal temperature is about 90 degrees Celsius, while the predetermined condensation removal time is approximately ten minutes when the heating element is energized for approximately 15 minutes.

This invention, including all embodiments shown and described herein, could be used alone or together and/or in combination with one or more of the features covered by one or more of the claims set forth herein, including but not limited to one or more of the features or steps mentioned in the bullet list in the Summary of the Invention and the claims. The TCP heater may take the form of the bezel and/or be molded to provide or define the bezel 20. Therefore it could provide the aesthetic role of the bezel 20 in addition to the heating source for deicing and condensation.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A headlamp and/or tail light assembly comprising:
a housing;
an outer lens;
a thermally conductive plastic situated in operative relationship with said outer lens; and
a heating element for heating said thermally conductive plastic;
wherein said thermally conductive plastic is situated a predetermined distance from said outer lens so that when said heating element is energized, said thermally conductive plastic becomes heated and causes heat to be directed towards said outer lens.

2. The headlamp and/or tail light assembly as recited in claim 1 wherein said heating element is situated inside said thermally conductive plastic.

3. The headlamp and/or tail light assembly as recited in claim 1 wherein said thermally conductive plastic is molded and comprises a longitudinal opening sized and adapted to receiving a mandrel and wire.

4. The headlamp and/or tail light assembly as recited in claim 1 wherein said thermally conductive plastic is molded into a predetermined shape adapted to be mounted into or on a component of said headlamp and/or tail light assembly.

5. The headlamp and/or tail light assembly as recited in claim 4 wherein said headlamp and/or tail light assembly comprises a bezel having a receiving area adapted and sized to receive said thermally conductive plastic.

6. The headlamp and/or tail light assembly as recited in claim 5 wherein said receiving area of said bezel is also adapted to receive at least one optical element in addition to said thermally conductive plastic.

7. The headlamp and/or tail light assembly as recited in claim 6 wherein said at least one optical element is at least one of a light guide, a daytime running light or a lens.

8. The headlamp and/or tail light assembly as recited in claim 7 wherein said thermally conductive plastic is molded in said predetermined shape that generally blends or is generally visually imperceptible from said at least one optical element.

9. The headlamp and/or tail light assembly as recited in claim 4 wherein said predetermined shape comprises a predetermined aesthetic appearance that generally complements an appearance of at least a portion of a component in said headlamp and/or tail light assembly.

10. The headlamp and/or tail light assembly as recited in claim 4 wherein said headlamp and/or tail light assembly comprises a bezel, said thermally conductive plastic being integral with said bezel.

11. The headlamp and/or tail light assembly as recited in claim 4 wherein said predetermined shape comprises a plurality of heat fins that are situated in operative relationship said predetermined distance from an inner surface of said lens.

12. The headlamp and/or tail light assembly as recited in claim 11 wherein said heat fins lie in a plane that is angled a predetermined angle with respect to said outer lens.

13. The headlamp and/or tail light assembly as recited in claim 11 wherein said predetermined distance is on the order of about 10.0 mm or less.

14. The headlamp and/or tail light assembly as recited in claim 1 wherein said headlamp and/or tail light assembly comprises a bezel comprising a bezel housing;
said thermally conductive plastic being situated in operative relationship with said bezel housing to cause heat to be conducted to produce hot air that is circulated through said headlamp and/or tail light assembly to perform at least one of clearing condensation or de-icing said lens.

15. The headlamp and/or tail light assembly as recited in claim 14 wherein said bezel housing comprises a first material having said thermally conductive plastic engaged to or integrally formed with said first material so that when said thermally conductive plastic is heated, heat is conducted through said first material to produce said hot air.

16. The headlamp and/or tail light assembly as recited in claim 15 wherein said heating element comprises a wire mounted on a mandrel and overmolded with said thermally conductive plastic.

17. A heating element for use in a headlamp and/or tail lamp assembly comprising:
a thermally conductive plastic material overmolded onto the heating element or surrounding the heating element and adapted to be heated by the heating element so that when the heating element heats the thermally conductive plastic, the thermally conductive plastic may heat a component in the headlamp and/or tail lamp assembly.

18. The heating element as recited in claim 17 wherein the heating element is overmolded with the thermally conductive plastic and situated in a bezel used in the headlamp and/or tail lamp assembly.

19. The headlamp and/or tail light assembly as recited in claim 1 wherein the heating element is coupled to a microcontroller that:
determines whether or not a de-icing mode or a condensation removal mode should be performed; and
performs at least one of the de-icing mode or the condensation removal mode in response to the determination made;
wherein during the de-icing mode, the microcontroller causes a power source to energize the heating element for a predetermined de-icing period of time at a predetermined de-icing temperature, and during the condensation removal mode, the microcontroller causes the power source to energize the heating element for a predetermined condensation removal period of time at a predetermined condensation removal temperature.

20. The headlamp and/or tail light assembly as recited in claim 19 wherein the predetermined de-icing period of time and predetermined de-icing temperature are less than the predetermined condensation removal period of time and predetermined condensation removal temperature, respectively.
